(19) United States
(12) Patent Application Publication
(10) Pub. No.: US 2013/0306234 A1
(43) Pub. Date: Nov. 21, 2013

(54) HONEYCOMB SANDWICH PANEL AND METHOD FOR MANUFACTURING THE SAME

(71) Applicant: LONGPONT CO., LTD., Shenzhen (CN)

(72) Inventors: Shiyi TAO, Shenzhen (CN); Peizhi HENG, Shenzhen (CN)

(73) Assignee: LONGPONT CO., LTD., Shenzhen (CN)

(21) Appl. No.: 13/951,421

(22) Filed: Jul. 25, 2013

Related U.S. Application Data
(63) Continuation-in-part of application No. PCT/CN2012/000095, filed on Jan. 19, 2012.

(30) Foreign Application Priority Data
Jan. 27, 2011 (CN) 201110029778.1

(51) Int. Cl. D21H 13/26; B29D 99/00

(52) U.S. Cl. CPC D21H 13/26; B29D 99/0021
USPC 156/264; 428/116

(57) ABSTRACT

A honeycomb sandwich panel of synthetic paper. The synthetic paper includes: between 20 and 75 wt. % of structural fibers and between 25 and 80 wt. % of bonding fibers. The structural fibers are poly(p-phenylene telephthalamide) (PPTA) fibers. The bonding fibers are fibrids of the PPTA. The structural fibers and the bonding fibers are shaped by a wet-forming papermaking method by a paper machine to yield the synthetic paper. The synthetic paper is coated, stacked, pressed, stretched, shaped, impregnated, cured, and sliced to form the honeycomb sandwich panel.

### CROSS-REFERENCE TO RELATED APPLICATIONS

This application is a continuation-in-part of International Patent Application No. PCT/CN2012/000095 with an international filing date of Jan. 19, 2012, designating the United States, now pending, and further claims priority benefits to Chinese Patent Application No. 201110029778.1 filed Jan. 27, 2011. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, TX 77079.

### BACKGROUND OF THE INVENTION

1. Field of the Invention

The invention relates to a honeycomb sandwich panel and a method for preparing the same.

2. Description of the Related Art

High performance synthetic materials have been widely used in technological fields having high requirements on security and portability, such as aerospace, military, electronics, machinery industry, and so on.

Because of its high strength, low distortion, high temperature resistance, chemical resistance, excellent insulation, and no fatigue, synthetic paper consisting of aramid fibers has been popularized. However, because of low fire resistance, such paper does not yet meet the requirements for many specialized applications. Another typical example of synthetic paper is prepared from carbon fibers and aramid fibers, but this type of paper also suffers from disadvantages, such as poor insulation and radioresistance.

Because the meta-aramid fibers (poly(m-phenylene telephthalamide)) decompose at a temperature of 370° C., while the para-aramid fibers (poly(p-phenylene telephthalamide)) decompose at a temperature of 500° C., the synthetic paper prepared from meta-aramid fibers has a poorer heat resistance than synthetic paper prepared from para-aramid fibers.

When para-aramid fibers are used in the form of short fibers as structural fibers for preparing synthetic paper, the selection of the material for the bonding fibers after the papermaking process is closely related to the paper-forming property. One typical method is using the polyester or polyphenylene sulfide as bonding fibers, which results in a point bonding effect, that is, multi-pores exist between fibers, the paper sheet is porous. When such synthetic paper is used for preparing a honeycomb plate, the permeability of the resin is very difficult to control; besides, when a large amount of the polyester is used, the hot strength of the honeycomb sandwich panel does meet the usual requirements. Another typical method is using the pulps of the para-aramid as the bonding fibers to produce synthetic paper containing 100% of the para-aramid fibers. However, the pulps of the para-aramid are commonly prepared by cutting the para-aramid short, fibrillating by a mill or a beater, which leads to a low strength of the synthetic paper and restricts the use of the synthetic paper.

### SUMMARY OF THE INVENTION

In view of the above-described problems, it is one objective of the invention to provide a honeycomb sandwich panel that has excellent compression modulus and shear modulus.

To achieve the above objective, in accordance with one embodiment of the invention, there is provided a honeycomb sandwich panel being prepared from synthetic paper. The synthetic paper comprises: between 20 and 75 wt. % of structural fibers; and between 25 and 80 wt. % of bonding fibers. The structural fibers are poly(p-phenylene telephthalamide) (PPTA) fibers. The bonding fibers are fibrids of the PPTA. The structural fibers and the bonding fibers are shaped by a wet-forming papermaking method by a paper machine to yield the synthetic paper. The synthetic paper is coated, stacked, pressed, stretched, shaped, impregnated, cured, and sliced to form the honeycomb sandwich panel.

In a class of this embodiment, the synthetic paper comprises: between 20 and 65 wt. % of the structural fibers; and between 35 and 80 wt. % of the bonding fibers. The structural fibers are the PPTA fibers. The bonding fibers are the fibrids of the PPTA. The structural fibers and the bonding fibers are shaped by the wet-forming papermaking method by the paper machine to yield the synthetic paper.

In a class of this embodiment, the synthetic paper comprises: between 35 and 60 wt. % of the structural fibers; and between 40 and 65 wt. % of the bonding fibers. The structural fibers are the PPTA fibers. The bonding fibers are the fibrids of the PPTA. The structural fibers and the bonding fibers are shaped by the wet-forming papermaking method by the paper machine to yield the synthetic paper.

In a class of this embodiment, the synthetic paper is prepared according to the following steps:
1) defibering the PPTA fibers to yield pulps A having a concentration of the PPTA fibers of between 0.5 and 5 wt. %;
2) defibering the fibrids of the PPTA to yield pulps B having a concentration of the fibrids of the PPTA of between 0.05 and 3 wt. %;
3) mixing the pulps A with the pulps B to form paper pulps;
4) papermaking and shaping the paper pulps;
5) drying, and preheating the paper pulps; and
6) hot rolling a product.

In a class of this embodiment, in step 6), a linear pressure is controlled between 200 and 300 kg/cm, a surface temperature of a roller is controlled between 280 and 340° C., and a rolling speed is controlled between 3 and 30 m/min

In a class of this embodiment, a beating degree of the fibrids of the PPTA is controlled at between 25 and 75° SR.

In a class of this embodiment, the structural fibers are PPTA short fibers and/or pulps of the PPTA having a fineness of between 1 and 2 d, and a length of between 0.5 and 8 mm.

In a class of this embodiment, the structural fibers are the PPTA short fibers and/or the pulps of the PPTA having a fineness of between 1 and 2 d, and a length of between 1.5 and 8 mm.

A method for preparing the honeycomb sandwich panel comprises the following steps:
1) coating the synthetic paper;
2) drying the synthetic paper, cutting the synthetic paper according to a desired dimension, and stacking the synthetic paper;
3) heating and pressing a stacked synthetic paper to produce a honeycomb block;
4) stretching the honeycomb block by a drawing machine to a desired pore size, and fixing the honeycomb block by a fixed support;
5) impregnating the honeycomb block into a impregnating tank;
6) drying, and shaping a product of step 5);
7) curing the product; and
8) slicing the product into pieces according to a desired thickness to yield the honeycomb sandwich panel.

In a class of this embodiment, the method for preparing the honeycomb sandwich panel comprises the following steps:

1) coating the synthetic paper with an adhesive;

2) drying the synthetic paper at a temperature of between 100 and 120° C., cutting the synthetic paper according to a desired dimension, and stacking the synthetic paper;
3) heating and pressing the stacked synthetic paper by a press to produce the honeycomb block; controlling a pressure of between 5 and 7 kg/cm², a temperature of 120° C. or 180° C., and a pressing time of between 6 and 12 h;
4) stretching the honeycomb block by the drawing machine according to the desired pore size, and fixing the honeycomb block by the fixed support for avoiding retraction;
5) impregnating the honeycomb block into an impregnating material in the impregnating tank for between 4 and 8 h; the impregnating material comprising an epoxy resin and a phenolic resin;
6) drying, and shaping the product at the temperature of 120° C.;
7) curing the product in a drying room at the temperature of 180° C. for between 4 and 8 h; and
8) slicing the product according to the desired thickness by a slicing machine to yield the honeycomb sandwich panel.

The poly(p-phenylene telephthalamide) (PPTA) fibers also called para-aramid fibers.

The bonding fibers of the invention are the fibrids of the PPTA, which are prepared by transporting a PPTA resin having a certain viscosity to a precipitation machine; adding a controllable coagulating composition to coagulate the PPTA resin; controlling a rotor speed of the precipitation machine of between 6,000 and 7,000 rpm so as to provide the synthetic paper with excellent shear modulus and to allow the fibers to precipitate in the form of strip films; washing and beating the fibers to yield the fibrids of the PPTA. The beating process is to defiber the PPTA so as to increase a specific area of the fibribs and reinforce the bond energy between fibers. The quality of the fibrds is directly related to the mechanical strength of the synthetic paper. The fibrids of the PPTA are added to form the paper pulps so as to provide the paper pulps with a paper-forming property similar to plant pulps, and ensure that the paper pulps before hot rolling has a good original strength, and the strength is largely improved in the hot rolling process and the heating and pressurizing process of the PPTA fibers. The beating degree of the fibrids of the PPTA is controlled at between 25 and 75° SR.

The strength, density, and permeability of the wholly para-aramid fiber paper will directly affect the manufacturing of the honeycomb sandwich panel. If the paper strength is low, the machining requirements cannot be satisfied; if the density is low and the permeability is large, the stretching effect is bad; if the density is high and the permeability is low, the shaping effect cannot be achieved.

The invention uses the wholly para-aramid fibers (PPTA fibers) to produce the PPTA honeycomb sandwich panel, so that the product has excellent compression modulus and shear modulus, and can be widely used in aerospace, military, electronics, machinery industry, and other industries having high requirements on the safety and portability.

### DETAILED DESCRIPTION OF THE EMBODIMENTS

For further illustrating the invention, experiments detailing a honeycomb sandwich panel are described below. It should be noted that the following examples are intended to describe and not to limit the invention.

Performance measurements of synthetic paper used for preparing the honeycomb sandwich panel were carried out from the following aspects according to corresponding national standards:
mass GB/T 451.3-2002
thickness GB/T 451.3-2002
density GB/T 451.3-2002
tensile strength GB/T 453-2002
percentage elongation GB/T 453-2002
tear strength GB/T 455-2002

Raw materials for preparing the synthetic paper comprise:

Para-aramid fibers: poly(p-phenylene telephthalamide) (PPTA) fibers, produced by Teijin Lid., Japan, trade name: twaron01080.

Fibrids of the para-aramid: fibrids of the PPTA, produced by Teijin Lid., Japan, trade name: twaron®08016 .

Pulps of the para-aramid: pulps of the PPTA, produced by Teijin Lid., Japan, trade name: twaron01094.

### Example 1

Synthetic paper was prepared by raw materials comprising 35 parts (herein “part” referring to “weight part”) of the para-aramid fibers or the pulps of the para-aramid, and 65 parts of the fibrids of the para-aramid.

80 parts of the para-aramid fibers were collected to prepare a first solution comprising 1 wt. % of the para-aramid fibers. The first solution was defibered by using a defibering machine to produce pulps A. 20 parts of the fibrids of the para-aramid were collected to prepare a second solution comprising 2 wt. % of the fibrids of the para-aramid. The second solution was defibered by using a hydraulic pulper, milled, and beaten, during which the beating degree was controlled at 75° SR, to produce pulps B. The pulps A and the pulps B were evenly mixed in a pool to produce paper pulps. 5 parts of a polyethylene oxide was added to a pressure stabilizing box. A pressure head was adjusted by the pressure stabilizing box so as to evenly distribute the paper pulps to a paper-forming mesh and allow a superfluous paper pulps to overflow to a white pool. When the paper pulps flowed along the paper-forming mesh, water was separated from the paper pulps under the force of a couch roll. A resulting wet paper sheet was transferred from the paper-forming mesh to a woolen blanket, and dehydrated in a vacuum box by wet pressing, and was further dried in a dryer. A paper sheet was then hot rolled by a hot mill. A linear pressure of a hot rolling line was controlled at between 200 and 300 kg/cm, a surface temperature of a roller was controlled at between 280 and 340° C., and a rolling speed was controlled at between 3 and 30 m/min. After being hot rolled, the paper sheet was finished by a calender, a temperature of which was controlled at between 170 and 190° C. to yield the synthetic paper. The synthetic paper was then coated, stacked, pressed, stretched, shaped, impregnated, cured, and sliced to form the honeycomb sandwich panel. Mechanical properties of the synthetic paper are shown in Table 1.

TABLE 1
Mechanical properties of synthetic paper and honeycomb sandwich panel

| Mechanical property | Unit | Result |
|---|---|---|
| Mass | g/m² | 42.8 |
| Thickness | mm | 0.049 |
| Density | g/cm³ | 0.87 |
| Tensile strength | KN/m MD | 1.62 |

| | | | Shear | | Shear | |
|---|---|---|---|---|---|---|
| | | Flat crush | strength | | modulus | |
| Fibrids | | strength | Mpa | | Mpa | |
| of PPTA % | PPTA fibers % | Mpa | L | W | L | W |
| 65 | 35 | 1.18 | 0.65 | 0.43 | 27.60 | 24.10 |

### Example 2

Synthetic paper was prepared by raw materials comprising 25 parts of the para-aramid fibers or the pulps of the para-aramid, and 75 parts of the fibrids of the para-aramid.

Herein the amounts of the ingredients were adjusted, but the preparation method of the synthetic paper and the honeycomb sandwich panel are the same as that in Example 1. Mechanical properties of the synthetic paper and the honeycomb sandwich panel are shown in Table 2.

TABLE 2
Mechanical properties of synthetic paper and the honeycomb sandwich
panel

| Mechanical property | Unit | Result |
|---|---|---|
| Mass | g/m² | 43.1 |
| Thickness | mm | 0.050 |
| Density | g/cm³ | 0.86 |
| Tensile strength | KN/m MD | 1.45 |

| | | | Shear | | Shear | |
|---|---|---|---|---|---|---|
| | | Flat crush | strength | | modulus | |
| Fibrids | | strength | Mpa | | Mpa | |
| of PPTA % | PPTA fibers % | Mpa | L | W | L | W |
| 75 | 25 | 1.12 | 0.62 | 0.40 | 27.40 | 23.60 |

Example 3

Synthetic paper was prepared by raw materials comprising 60 parts of the para-aramid fibers or the pulps of the para-aramid, and 40 parts of the fibrids of the para-aramid.

Herein the amounts of the ingredients were adjusted, but the preparation method of the synthetic paper and the honeycomb sandwich panel are the same as that in Example 1. Mechanical properties of the synthetic paper and the honeycomb sandwich panel are shown in Table 3.

TABLE 3
Mechanical properties of synthetic paper and the honeycomb sandwich
panel

| Mechanical property | Unit | Result |
|---|---|---|
| Mass | g/m² | 43.4 |
| Thickness | mm | 0.051 |
| Density | g/cm³ | 0.85 |
| Tensile strength | KN/m MD | 1.38 |

| | | | Shear | | Shear | |
|---|---|---|---|---|---|---|
| | | Flat crush | strength | | modulus | |
| Fibrids | | strength | Mpa | | Mpa | |
| of PPTA % | PPTA fibers % | Mpa | L | W | L | W |
| 40 | 60 | 0.77 | 0.56 | 0.33 | 26.30 | 15.20 |

### Example 4

Synthetic paper was prepared by raw materials comprising 65 parts of the para-aramid fibers or the pulps of the para-aramid, and 35 parts of the fibrids of the para-aramid.

Herein the amounts of the ingredients were adjusted, but the preparation method of the synthetic paper and the honeycomb sandwich panel are the same as that in Example 1. Mechanical properties of the synthetic paper and the honeycomb sandwich panel are shown in Table 4.

TABLE 4
Mechanical properties of synthetic paper and the honeycomb sandwich
panel

| Mechanical property | Unit | Result |
|---|---|---|
| Mass | g/m² | 42.8 |
| Thickness | mm | 0.049 |
| Density | g/cm³ | 0.87 |
| Tensile strength | KN/m MD | 1.32 |

| | | | Shear | | Shear | |
|---|---|---|---|---|---|---|
| | | Flat crush | strength | | modulus | |
| Fibrids | | strength | Mpa | | Mpa | |
| of PPTA % | PPTA fibers % | Mpa | L | W | L | W |
| 35 | 65 | 0.70 | 0.52 | 0.27 | 24.00 | 11.50 |

### Example 5

Synthetic paper was prepared by raw materials comprising 80 parts of the para-aramid fibers or the pulps of the para-aramid, and 20 parts of the fibrids of the para-aramid.

Herein the amounts of the ingredients were adjusted, but the preparation method of the synthetic paper and the honeycomb sandwich panel are the same as that in Example 1. Mechanical properties of the synthetic paper and the honeycomb sandwich panel are shown in Table 5.

TABLE 5
Mechanical properties of the synthetic paper and the honeycomb sandwich
panel

| Mechanical property | Unit | Result |
|---|---|---|
| Mass | g/m² | 42.4 |
| Thickness | mm | 0.048 |
| Density | g/cm³ | 0.88 |
| Tensile strength | KN/m MD | 1.18 |

| | | | Shear | | Shear | |
|---|---|---|---|---|---|---|
| | | Flat crush | strength | | modulus | |
| Fibrids | | strength | Mpa | | Mpa | |
| of PPTA % | PPTA fibers % | Mpa | L | W | L | W |
| 20 | 80 | 0.66 | 0.50 | 0.25 | 21.2 | 11.1 |

### Example 6

Synthetic paper was prepared by raw materials comprising 35 parts of the para-aramid fibers, and 65 parts of the pulps of the para-aramid. The fibrids of the para-aramid were substituted by the pulps of the para-aramid, and the amounts of the ingredients were the same as that of the Example 1. The pulps of the para-aramid are prepared by cutting the para-aramid fibers short, milling, and beating the short fibers for fibrillation. The method for preparing the synthetic paper is the same as that in Example 1. Mechanical properties of the synthetic paper are shown in Table 6.

TABLE 6
Mechanical properties of the synthetic paper

| Mechanical property | Unit | Result |
|---|---|---|
| Mass | g/m² | 44 |
| Thickness | mm | 0.052 |
| Density | g/cm³ | 0.85 |
| Tensile strength | KN/m MD | 0.88 |

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A honeycomb sandwich panel comprising synthetic paper, wherein the synthetic paper comprises: between 20 and 75 wt. % of structural fibers and between 25 and 80 wt. % of bonding fibers;
the structural fibers are poly(p-phenylene telephthalamide) (PPTA) fibers;
the bonding fibers are fibrids of the PPTA;
the structural fibers and the bonding fibers are shaped by a wet-forming papermaking method by a paper machine to yield the synthetic paper; and
the synthetic paper is coated, stacked, pressed, stretched, shaped, impregnated, cured, and sliced to form the honeycomb sandwich panel.

2. The honeycomb sandwich panel of claim 1, wherein the synthetic paper comprises:
between 20 and 65 wt. % of the structural fibers and between 35 and 80 wt. % of the bonding fibers.

3. The honeycomb sandwich panel of claim 2, wherein the synthetic paper comprises:
between 35 and 60 wt. % of the structural fibers and between 40 and 65 wt. % of the bonding fibers.

4. The honeycomb sandwich panel of claim 1, wherein the synthetic paper is prepared according to the following steps:
1) defibering the PPTA fibers to yield pulps A having a concentration of the PPTA fibers of between 0.5 and 5 wt. %;
2) defibering the fibrids of the PPTA to yield pulps B having a concentration of the fibrids of the PPTA of between 0.05 and 3 wt. %;
controlling a beating degree of the fibrids of the PPTA at between 25 and 75° SR;
3) mixing the pulps A with the pulps B to form paper pulps;
4) papermaking and shaping the paper pulps;
5) drying, and preheating the paper pulps; and
6) hot rolling a product at a linear pressure of between 200 and 300 kg/cm, a surface temperature of a roller of between 280 and 340° C., and a rolling speed of between 3 and 30 m/min

5. The honeycomb sandwich panel of claim 1, wherein the structural fibers are PPTA short fibers and/or pulps of the PPTA having a fineness of between 1 and 2 d and a length of between 0.5 and 8 mm.

6. The honeycomb sandwich panel of claim 5, wherein the structural fibers are the PPTA short fibers and/or the pulps of the PPTA having a fineness of between 1 and 2 d and a length of between 1.5 and 8 mm.

7. A method for preparing the honeycomb sandwich panel of claim 1, the method comprising the following steps:
1) coating the synthetic paper;
2) drying the synthetic paper, cutting the synthetic paper according to a desired dimension, and stacking the synthetic paper;
3) heating and pressing a stacked synthetic paper to produce a honeycomb block;
4) stretching the honeycomb block by a drawing machine to a desired pore size, and fixing the honeycomb block by a fixed support;
5) impregnating the honeycomb block into a impregnating tank;
6) drying, and shaping a product of step 5);
7) curing the product; and
8) slicing the product into pieces according to a desired thickness to yield the honeycomb sandwich panel.

8. The method of claim 7, comprising the following steps:
1) coating the synthetic paper with an adhesive;
2) drying the synthetic paper at a temperature of between 100 and 120° C., cutting the synthetic paper according to the desired dimension, and stacking the synthetic paper;
3) heating and pressing the stacked synthetic paper by a press to produce the honeycomb block; controlling a pressure of between 5 and 7 kg/cm², a temperature of 120° C. or 180° C., and a pressing time of between 6 and 12 h;
4) stretching the honeycomb block by the drawing machine to the desired pore size, and fixing the honeycomb block by the fixed support for avoiding retraction;
5) impregnating the honeycomb block into an impregnating material in the impregnating tank for between 4 and 8 h, the impregnating material comprising an epoxy resin and a phenolic resin;
6) drying, and shaping the product at the temperature of 120° C.;
7) curing the product in a drying room at the temperature of 180° C. for between 4 and 8 h; and
8) slicing the product according to the desired thickness by a slicing machine to yield the honeycomb sandwich panel.
